(19) United States
(12) Patent Application Publication
(10) Pub. No.: US 2020/0305445 A1
(43) Pub. Date: Oct. 1, 2020

(54) PROTEIN HYDROLYSATES AS EMULSIFIER FOR BAKED GOODS

(71) Applicant: BASF SE, Ludwigshafen am Rhein (DE)

(72) Inventors: Thrandur HELGASON, Illertissen (DE); Dieter HIETSCH, Illertissen (DE); Peter HORLACHER, Illertissen (DE); Jochen KUTSCHER, Illertissen (DE); Selina MARZ, Illertissen (DE)

(21) Appl. No.: 16/759,337

(22) PCT Filed: Oct. 26, 2018
(86) PCT No.: PCT/EP2018/079405

§ 371 Date: Apr. 26, 2020

(30) Foreign Application Priority Data
Oct. 26, 2017 (EP) 17198553.4

(51) Int. Cl. A21D 2/26; A21D 13/068; A21D 13/80; A23J 3/34; A23L 33/18

(52) U.S. Cl. CPC A21D 2/268; A21D 13/068; A21D 13/80; A23V 2002/00; A23J 3/346; A23L 33/18; A23J 3/344

(57) ABSTRACT

Use of a protein hydrolysate for the preparation of baked goods, preferably cakes, particularly fat free cakes, wherein the molecular weight of the protein hydrolysate is between 600 and 2400 Da and the solubility of the protein hydrolysate is at least 85%.

Traditionally sponge cakes are made by separately whipping air into egg white and egg yolk with each phase containing half of the sugar, and then carefully adding flour, starch and baking powder before baking. However, this method is too complicated for industrial scale cake production. Furthermore, the traditionally prepared foam is very sensitive to mechanical stress. Current industrial scale baking needs a fast method which produces foams fast and keeps the foam stable during handling and baking. This is achieved by addition of emulsifiers which help to generate foam much faster and secondly stabilize the foam during whipping and baking (Bennion & Bemford, 1997). Furthermore, by using emulsifiers, it is possible to whip the whole recipe (i.e. egg white, egg yolk, sugar, starch, wheat flour and baking powder) without negative effects.

Emulsifiers reduce interfacial tension by adsorbing to the interface between air and cake batter (water phase) and balancing out the interaction forces between air and water because they are amphiphilic. Reducing interfacial tension reduces the energy needed to create new interfaces between the batter and air droplets (Eugènie, S. P. et al. 2014). Therefore, lower interfacial tension improves air incorporation into the batter resulting in lighter foam after whipping. Secondly the right mixture of emulsifiers results in associative structures which substantially increase viscoelasticity of the batter (Richardsson et al. 2004). Increased viscoelasticity will firstly improve whipping properties as well as stabilizing the foam against breakdown (Eugénie, S. P. et al. 2014). Foam breakdown means the air droplets coalesce and form larger air droplets. This can occur during mechanical processing of the foam and during baking. Currently there are applied conventional emulsifiers such as mono- and diglycerides of fatty acids but cake volumes produced with these emulsifiers are limited.

Baking industry is interested to further extend the volume of a cake based on the same amount of batter or to reduce the amount of ingredients and therefore costs to produce the same volume of cake without reducing cake quality, which is a fine, even crumb structure without big air bubble indicating a blown-up cake. Further, consumer trends for more natural products and lower number of ingredients on the product label create a demand for an alternative to chemical or synthetic emulsifiers such as mono- and diglycerides of fatty acids and synthetic fatty acid esters.

Using only proteins to replace other conventional, chemical, synthetic emulsifier did not adequately aerate sponge cake systems. Either no foam was created, or the foam was not stable during the baking procedure.

EP 2214498 describes the application of oxidase and lipase enzymes originating from unhydrolyzed potato protein in bread.

There are known methods of hydrolysis of proteins and enzymatic protein hydrolysis has been performed in the prior art to make e.g. ACE inhibitors US2004086958A or to treat diabetics US2003004095A. These applications focus on forming specific very short peptide chains often only few amino acids long but those very short amino acid chains are unable to stabilize foams (OPA-N values below 500). Other methods are described in US 2003175407A and US 2007172579A, where proteins were hydrolyzed using high pH above 10. They furthermore describe foaming properties of the resulting protein hydrolysate (alkali treated) systems. However, the alkali treatment is known to result in chemical modification of the amino acids of the protein resulting in loss of nutritional properties and furthermore formation of unusual amino acids (Tavano O. L. 2013, Provansal et al. 1975). The alkali hydrolysis results in high MW protein hydrolysates (OPA-N value 3450) which result in a foam with large air droplets. After baking this foam, the cake structure will be cruder and therefore not as fine as the cake with conventional emulsifiers. U.S. Pat. No. 5,486,461 discloses simply a method for production of a casein hydrolysate. And EP 2296487 discloses the use wheat protein hydrolysate for nutritional purposes in beverages, energy drinks and sport drinks but not as emulsifiers.

Objective of the present invention therefore was to provide a natural emulsifier which allows to generate a fine foam and to stabilize foam under stressful environments such as baking and to result in a higher cake volume compared to conventional emulsifiers while showing the same preferred even cake crumb structure.

Surprisingly it was found that this objective is solved by using a protein hydrolysate with a MW in the range of 600 to 2400 Da and a solubility of at least 85%.

The invention refers to the use of a protein hydrolysate for the preparation of baked goods, preferably cakes, particularly fat free cakes, wherein the molecular weight of the protein hydrolysate is between 600 and 2400 Da and the solubility of the protein hydrolysate is at least 85%. The MW according to the invention is an average apparent MW value determined by measuring OPA-N (Frister H. et al. 1988) as described below in the methods part. The higher the solubility is, the lower will be the batter density and the higher will be the resulting cake volume. Therefore, preferably the solubility is at least 88, 89, 90, 91, 92, 93, 94, 95, 95, 96, 97, 98 or 99%, particularly 100%.

The baked goods according to the invention are products where lifting of the batter is performed without yeast or sour dough but is basically done by mechanical aerating the batter. Fat free in the context of the inventions means a dough is free from butter, concentrated butter, margarine or oil generally used for preparation of cakes but it can comprise ingredients such as cocoa or ground nuts which themselves can comprise some amount of oil. Fat free does not refer to fillings or icing after baking such as whipped cream or butter crème. Preferred cakes are sponge cake, swiss rolls or angel cakes.

Preferably the protein is a plant or animal protein and more preferably at least one selected from the group consisting of wheat, soy, rice, potato, pea, sunflower, rape seed, lupin and milk protein such as casein, whey protein or beta-lactoglobulin. Particularly preferred are wheat protein or casein. Each protein has a different MW and structure and therefore the optimal range of different protein hydrolysates depend of the individual protein.

According to one embodiment the batter density of a standard cake recipe including the protein hydrolysate after whipping and before baking is below 450 g/I. The whipping is performed according to methods part “Whipping”. Depending on the content of starch and flour there are 2 standard recipes of batter (see table 1) where the different amounts of protein hydrolysate are added (see table 2). The quality of a protein hydrolysate to create a fine and stable foam is determined by the batter density as a lower density means, the batter is comprising more air bubbles and the final cake volume will be higher if there is also sufficient stabilization during baking. Preferably the batter density is below 420, 400, 380, 370, 360, 350, 340, 330, 320 g/I, or particularly below 310 g/I.

Preferably the maximum molecular weight (MW) of the protein hydrolysate is 2300 Da, preferably 2200, 2100, 2000, 1900, 1800 or 1700 Da. The lower the molecular weight is, the finer the resulting cake structure after baking will be with respect to the air pockets in the cake. But too small MW results in a loss of stability during whipping or baking and the batter will have higher density or batter will collapse during baking. Therefore, according to a preferred embodiment the minimum molecular weight of the protein hydrolysate is 650 Da, preferably 660, 670, 680, 690, 700, 710, 720, 750 or 800 Da.

According to one embodiment of the invention the molecular weight of a wheat protein hydrolysate is between 1300 and 2200 Da, preferably between 1400 and 2100 Da, particularly between 1500 and 2000 Da, most preferably between 1600 and 2000 Da.

According to another embodiment of the invention the molecular weight of a casein hydrolysate is between 650 and 1000 Da, preferably between 670 and 900 Da or 690 and 900 Da, particularly between 680 and 870 Da or 720 and 870 Da.

The amount of protein hydrolysate for the use according to the invention is depending on the content of flour in the batter. In one embodiment of an only starch comprising batter the amount of protein hydrolysate, preferably casein hydrolysate, in the batter is at least 0.8% (w/w), preferably at least 1.2% (w/w), more preferably at least 1.6% (w/w), particularly at least 2.0% (w/w). The optimal dosing depends on the individual protein hydrolysate, the batter variation and additional ingredients each baker makes. In a standard batter recipe according to table 1 the preferred casein hydrolysate dosage is 10 g or 1.6% w/w and for a wheat protein hydrolysate its preferably 15 g or 2.4% w/w.

In another embodiment of a wheat flour comprising batter (see table 1, first standard cake recipe with a ratio of flour:starch of 6:4) the amount of protein hydrolysate, preferably casein hydrolysate, is at least 2.0% (w/w), preferably at least 2.4% (w/w), more preferably at least 3.0% (w/w), particularly at least 3.2% (w/w). With a lower or higher flour:starch ratio the minimal amount of protein hydrolysate will be adjusted accordingly as more flour generally requires more protein hydrolysate.

According to one specific embodiment the maximum amount of casein hydrolysate to be applied is 5% (w/w), preferably 4% (w/w), particularly 3.5% (w/w).

According to another specific embodiment the maximum amount of wheat protein hydrolysate to be applied is 7% (w/w), preferably 6% (w/w), particularly 5% (w/w).

Preferably the protein hydrolysate is an enzymatically hydrolyzed protein hydrolysate. Preferred enzymes are endopeptidases, particularly alkaline protease. Examples of such enzymes are Alkalase, Neutrase or Flavorzyme (Novozymes). Principally hydrolysis can also be performed chemically, e.g. by hydroxide, but conditions and the process have to be carefully controlled to obtain a hydrolysate in the desired MW range.

In a preferred embodiment, the protein hydrolysate is unfiltered after hydrolysis, preferably enzymatically hydrolysis. It is also possible to add a filtering step where solubility after hydrolysis is too low and needs to be increased to obtain higher solubility, lower batter density and higher cake volume.

In another embodiment, the protein hydrolysate is neutralized to about pH 7.0 after hydrolysis, preferably enzymatically hydrolysis, by application of any acid suitable for food ingredients, such as but not limited to lactic acid, phosphoric acid, hydrochloric acid, citric acid or sulfuric acid, before spray drying. This pH neutral spray dried product has advantages depending on the other batter ingredients such as baking powder during processing.

As one objective of the invention is to provide a natural non chemical emulsifier for baked goods, a batter or cake according to the invention is preferably free from isolated emulsifiers selected form the group consisting of Lecithin (E322); Polysorbates (E432-436); Ammonium phosphatides (E442); Sodium, potassium and calcium salts of fatty acids (E470); Mono- and diglycerides of fatty acids (E471); Acetic acid ester of mono and diglycerides (E472a); Lactic acid ester of mono and diglycerides (E472b); Citric acid ester of mono and diglycerides (E472c); Diacetyl tartaric acid esters of mono- and diglycerides (E472e); sucrose esters of fatty acids (E473); sucroglycerides (E474); Propylene Glycol Esters of Fatty Acids (E477); Polyglycerol ester of fatty acid (E475); polyglycerol ester of caster oil fatty acids (E476); thermally oxidized soya bean oil interacted with mono- and diglycerides of fatty acids (E479) and sodium and calcium stearyl lactylate (E481 and E482) as all these emulsifiers have to be listed with their E number on a product label. Isolated emulsifiers in the context of this application mean emulsifiers prepared and added as a separate component to the dough and not as a naturally occurring part of an ingredient such as e.g. lecithin present in egg yolk.

In one embodiment, the batter is only comprising starch, in another embodiment it's a mixture of starch and flour, particularly wheat flour, with a flour:starch ratio as from 90:10 to 10:90 depending of cake product. Preferably, in such mixtures the amount of mono- and di-glycerides in the flour is below 1 g, preferably below 0.5 g, particularly 0 g, per kg flour. The ratio is therefore depending on mono- and di-glycerides content of the flour, if the content is low, a higher flour ratio is possible compared to a higher mono- and di-glycerides content.

Preferably the volume of a standard cake comprising the protein hydrolysate, which is a cake baked of 550 g batter according to the flour/starch or starch recipe (table 1 and baking example), is at least 3500 ml, preferably at least 3600, 3700, 3800, 3900 ml or particularly at least 4000 ml. The volume after baking is an important quality parameter together with the crumb structure of the cake. The volume can be determined by various methods such as laser scanning or rapeseed displacement method. A sponge cake is expected to be light and having an even structure. High volumes often result in big air pockets and an irregular structure (see Table 2, Hyfoama examples).

In a preferred embodiment, the protein hydrolysate is used as a lyophilized or spray dried powder, preferably comprising additional ingredients selected from sugars and polysaccharides. It is also possible to apply the hydrolysate as a liquid or concentrate directly after hydrolysis, but protein liquids are generally more difficult to stabilize and to preserve than dried powders, especially for food applications.

In a preferred embodiment the protein hydrolysate is conjugated with at least one reducing sugar. An advantage of this conjugation is the reduction of a bitter taste of some protein hydrolysates without influencing or reducing the baking performance of the hydrolysates. Conjugation in the context of this application means more than just mixing hydrolysate and sugar but performing a Maillard reaction at elevated temperature. The conjugation is initiated by a condensation of amino groups of the protein hydrolysate with the carbonyl groups on the reducing sugar, resulting in Schiff base formation and rearrangement to Amadori and Heyns products. The conjugation can be performed in solutions/dispersions or in dry state and is preferably performed in solution with high concentration of peptides and sugars with reducing end. The hydrolysates treated by this conjugation are called “conjugated hydrolysates”. The process of conjugation is controlled by selecting e.g. pH, temperature and reaction time depending on the respective protein hydrolysate and its MW. Examples and results of conjugation reactions are shown in Table 3: Higher amount of sugar results in less bitterness and higher pH results in less bitterness as well as longer reaction time further reduces bitterness. Preferably temperature is about 65° C. as higher temperatures need very accurate control of the process to avoid changes in color of the conjugate which are not desired for some applications where a white powder is preferred. The level of conjugation is characterized by determining the degree of conjugation.

A taste analysis performed (table 3) shows a clear correlation between bitterness and degree of conjugation. Conjugated peptides had lower bitter taste compared to the same combination of protein hydrolysate and sugar without conjugation process. This clearly indicates that the bitter taste masking is not caused by the sweet taste of the sugar but by the specific conjugation reaction.

According to the invention any reducing sugar suitable for food products is possibly applied. Preferably the sugar is selected from the group consisting of glucose, fructose, maltose, lactose, galactose, cellobiose, glyceraldehyde, ribose xylose and mannose.

According to one embodiment the degree of conjugation, measured according to the method explained below, is at least 10%, preferably 15%, 20%, 25%, 30%, 35% or 40%. With a degree of conjugation of at least 10% already a significant bitterness reduction is achieved, whereas reduction of bitter taste by 50% can be reached by a degree of conjugation of at least 20% or more.

According to one embodiment the molar ratio of reducing sugar to peptide is from 0.5 to 2.0, preferably from 1.0 to 1.7. For glucose this corresponds to a weight ratio of glucose to hydrolysate from 10:90 to 40:60, preferably from 20:80 to 30:70. The higher the amount of sugar is, the lower is the bitterness of the conjugated hydrolysate as more bitter taste causing groups can react with the reducing sugar. Therefore, the amount of sugar is higher for more bitter hydrolysates such as casein hydrolysate than for less bitter peptides such as wheat protein hydrolysate and will be adjusted depending of the individual bitterness.

The invention also refers to conjugated wheat protein or casein hydrolysates, which are suitable as non-bitter tasting emulsifiers for food products, preferably baking products, wherein the hydrolysate is conjugated with a reducing sugar and the degree of conjugation is at least 10%, preferably 15%, 20%, 35%, 30%, 35% or 40% and the protein hydrolysates have a MW between 600 and 2400 Da. Preferably the MW is between 650 and 2000 Da depending on the origin of the protein. For casein hydrolysate conjugates the MW of the hydrolysate is preferably between 650 and 1000 Da, particularly between 670 and 900 Da. For wheat protein hydrolysates the MW of the hydrolysate is preferably between 1300 and 2200 Da, particularly between 1500 and 2000 Da.

According to one embodiment the molar ratio of reducing sugar to peptide is from 0.5 to 2.0, preferably from 1.0 to 1.7. For glucose this corresponds to a weight ratio of glucose to hydrolysate from 10:90 to 40:60, preferably from 20:80 to 30:70. The higher the amount of sugar is, the lower is the bitterness of the conjugated hydrolysate as more bitter taste causing groups can react with the reducing sugar. Therefore, the amount of sugar is higher for more bitter hydrolysates such as casein hydrolysate than for less bitter peptides such as wheat protein hydrolysate and will be adjusted depending of the individual bitterness.

Methods

Protein Hydrolysis

General Process Description for Protein Hydrolysates

Proteins are dispersed in water followed by pH adjustment. The pH is adjusted to the optimal pH range for each enzyme and can thus vary depending on which enzyme is used. The common processing temperature is 50-65° C. However, this can also vary depending on which enzyme is used since each enzyme has a specific reaction temperature optimum. When temperature and pH conditions of the protein dispersion are stable, the enzyme is added to start the protein hydrolysis reaction. The reaction time dictates the MW of the protein hydrolysate that is produced thus protein hydrolysate properties can be controlled by the reaction time. When the desired MW is achieved, the reaction is stopped by either increasing temperature to denature the enzyme or by changing pH. Common denaturation temperatures are 80-90° C., depending on the type of enzyme used. After denaturation, the protein hydrolysate is lyophilized using, but not limited to, spray drying or freeze drying. To modify the application properties of the material or the handling of the powder it is possible to add sugars, polysaccharides, lipids and other ingredients before the lyophilization procedure.

Wheat Protein Hydrolysates

Gradually disperse 100 g of wheat protein into 1050 g of 55-65° C. warm water (temperature is kept during the whole hydrolysis time), and adjust pH to 9.0-10.5 using Ca(OH)₂, then add 0.2-1.0 g of Alcalase, and slowly disperse 200-300 g wheat protein in the next 5-30 min. Add 0.5-2.0 g Alcalase and stir material for 10-30 min. Disperse 200-350 g of protein (dues to high viscosity at this point, disperse protein using high speed stirrer for 3 min) and 0.5-2.0 g of Alcalase, stir for 30-120 min. while keeping the pH constant at pH 9.0-10.5 using Ca(OH)₂. Optionally adjust the pH to 7.0-7.5 using food acids such as phosphoric acid, Hydrocloric acid, citric acid, lactic acid or sulfuric acid. Stop enzymatic reaction by heating to 80-84° C., and holding the temperature for 15 min. The solution is spray dried to form a powder.

### Example W5 and W6 was Produced According to the Following Process

Gradually disperse 100 g of wheat protein into 1050 g of 58° C. warm water (temperature is kept during the whole hydrolysis time), and adjust pH to 9.5 using Ca(OH)₂, then add 0.5 g of Alcalase, and slowly disperse 250 g wheat protein in the next 10 min. Add 1 g Alcalase and stir material for 20 min. Disperse 250 g of protein (dues to high viscosity at this point, disperse protein using high speed stirrer for 3 min) and 1 g of Alcalase, stir for 60 min. while keeping the pH constant at pH 9.5 using Ca(OH)₂. Stop enzymatic reaction by heating to 80-84° C. and holding the temperature for 15 min. The solution is spray dried to form a powder.

Casein Hydrolysates

Heat 21.5 kg tap water to 55-65° C. (temperature is kept during the whole hydrolysis time) and add 0-250 g NaOH (20% NaOH solution). Disperse 6-8 kg of casein into the warm water and adjust pH to 8.5-9.5 using 20% NaOH solution. Add 40-100 g of Alcalase, stir material for 15-60 min while slowly adding 5-12 kg of casein (pH is kept at 8.5-9.5). Add 40-100 of Alcalase and keep pH constant at pH 8.0-9.0 for 10-120 min using 20% NaOH solution. Optionally add 5-7 kg of Casein while keeping pH at 8.0-9.0 for 30-120 min. Then stir for 30-120 min while the pH is not kept constant, end pH will be 7.5-8.5. Optionally adjust the pH to 7.0-7.5 using food acids such as phosphoric acid, Hydrochloric acid citric acid, lactic acid or sulfuric acid. Stop enzymatic reaction by heating to 80-84° C., and holding the temperature for 15 min. The solution is spray dried to form a powder.

### Example C9 and C11 was Produced According to the Following Process

Heat 21.15 kg tap water to 60° C. (temperature is kept during the whole hydrolysis time) and add 182 g NaOH (20% NaOH solution). Disperse 6.93 kg of casein into the warm water and adjust pH to 9.0 using 20% NaOH solution. Add 87 g of Alcalase, stir material for 30 min while slowly adding 10.42 g of casein (pH is kept at 9.0). Add 87 of Alcalase and keep pH constant at pH 8.5 for 60 min using 20% NaOH solution. Then stir for 60 min while the pH is not kept constant during the last 60 min, end pH will be 7.9. Stop enzymatic reaction by heating to 80-84° C., and holding the temperature for 15 min. The solution is spray dried to form a powder.

Protein Hydrolysates Conjugation

70 to 90 g casein hydrolysate is dissolved in 86 to 110 g water, 10 to 30 g glucose is added to the solution at 65 or 85° C. and pH is adjusted to 8 or 8.5 with NaOH. The system is stirred while pH is kept constant using NaOH. After 30 or 60 minutes the system is spray dried to form powder.

Whipping

The baking performance of a protein hydrolysate is tested in a standard cake application (Table 1). A blend of 185 g native wheat starch, 150 g sugar, 2.2 g sodium bicarbonate, 3 g sodium acid pyrophosphate, 230 g whole egg and 30 g water was whipped up together with the protein hydrolysate in a planetary mixer (Hobart N 50, Dayton, Ohio, USA) for 5 minutes at step 3 and additional 30 seconds at step 2.

TABLE 1
standard cake recipes.

| | Standard | Standard starch | Example | |
|---|---|---|---|---|
| Material (in g) | flour/starch recipe | recipe | Spongolit | Example C2 |
| Spongolit | 0 | 0 | 20 | 0 |
| Protein hydrolysate | 0 | 0 | 0 | 10 |
| Wheat flour Type 405 | 112 | 0 | 112 | 0 |
| Wheat starch | 73 | 185 | 73 | 185 |
| Sugar | 150 | 150 | 150 | 150 |
| Natrium bicarbonate | 2.2 | 2.2 | 2.2 | 2.2 |
| Sodium acid | 3 | 3 | 3 | 3 |
| pyrophosphate | | | | |
| Eggs | 230 | 230 | 230 | 230 |
| Water | 30 | 30 | 30 | 30 |
| Total g | 600.2 | 600.2 | 620.2 | 610.2 |

Batter Density

After whipping, the batter density is determined by weighing the amount (g) of batter that fills a 250 ml bowl. The weight is multiplied with four to achieve a batter density in gram per liter. Example: 100 g batter in 250 ml bowl*4=batter density of 400 g/I

Baking and Standard Cake Volume

550 g batter is weighed into a round baking tin (26 cm diameter, 5 cm high) and baked at 195° C. for approx. 29 minutes in deck oven (Wachtel, Hilden, Germany) with opened draft.

The volume of the standard cake is determined by using a laser scanner (Volscan, Micro Stable Systems, Hamilton, Mass., USA).

Cake Structure Evaluation

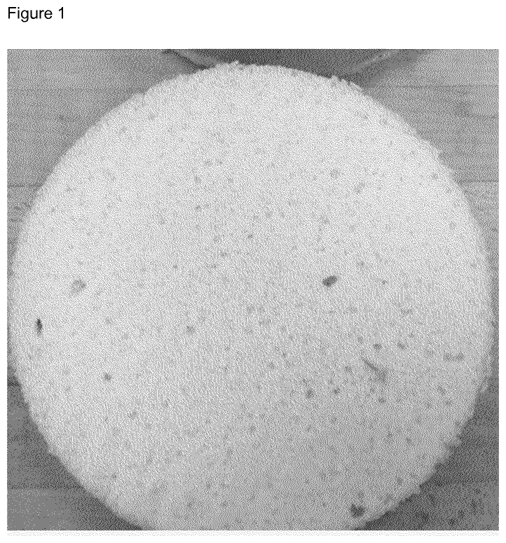

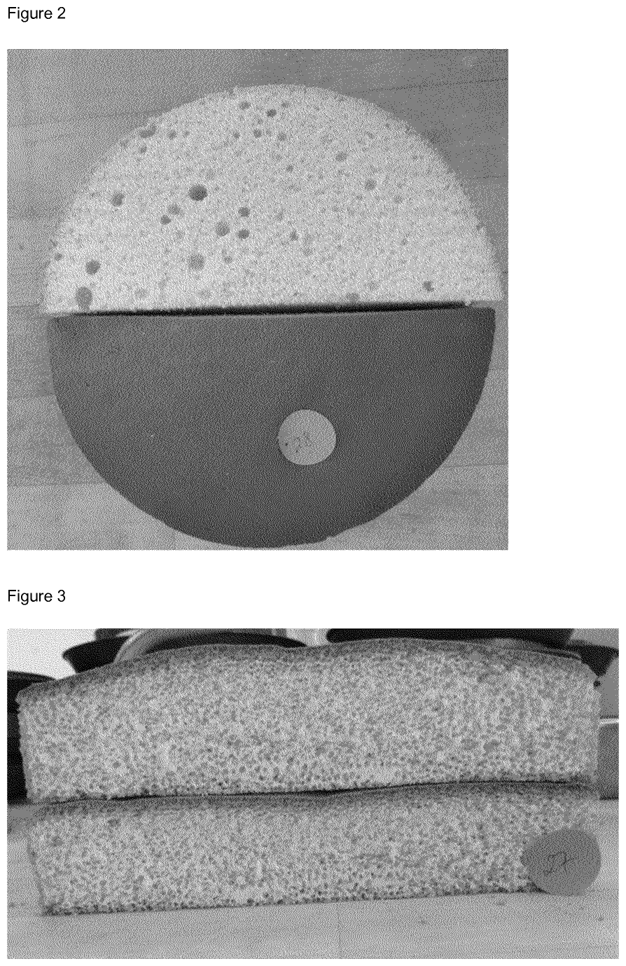

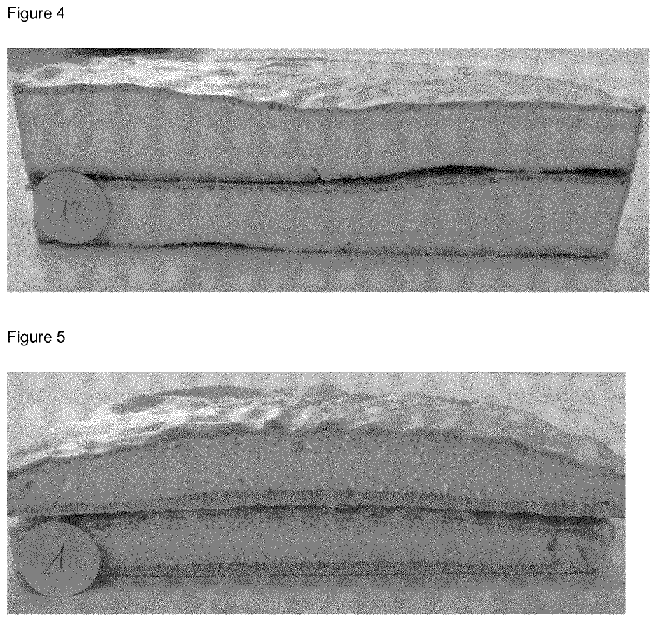

Cake structure evaluation is performed by letting the cake cool down to room temperature (store at room temperature for 1 hour) then the cake is cut horizontally in the middle to investigate the cake structure. The cake is rated to give ranking of 1-5 where 1 is good cake structure and 5 is a very bad cake structure as shown in the following examples and FIGS. 1-5:
1) The cake has no or minimal amount of large air pockets under the surface, crumb structure is fine and even across the whole cake. Cake volume is above 3300 ml (FIG. 1).
2) The cake has no or minimal amount of large air pockets under the surface, crumb structure is crude and inhomogeneous. Cake volume is above 3000 ml (FIG. 2).
3) Many air pockets under the surface, or very inhomogeneous/crude crumb structure. Cake volume is above 2800 ml (FIG. 3).
4) Cake surface is loose due to extensive amount of air pockets under the crust, or cake has partially fallen together during baking, Cake volume is above 2800 ml (FIG. 4).
5) Cake has completely fallen together during baking. Cake volume is below 2800 ml (FIG. 5).

Solubility

Solubility of the protein hydrolysate is determined for the protein hydrolysate powders after spray drying by dispersing 5 g protein hydrolysate powder in 92.5 g tap water with 2.5 g Clarcel DIC-B as filtration aide. Care must be taken that the protein hydrolysate powder does not form clumps when it is dispensed into the water, by adding it slowly to the water phase. Dispersion is then adjusted to pH 8±0.5 using NaOH or HCl. The dispersion/solution is stirred with a magnetic stirrer at 200 rpm for 1 hour. The sample is filtered under pressure at 2.5 bars using Seitz K 300 R001/4 cm filter paper. Protein concentration was measured before filtration and in the filtrate. Solubility was calculated by the following formula: (g protein in filtrate/g protein before filtration)*100=% solubility of protein hydrolysate

Protein Concentration (Dumas)

The protein concentration is analyzed per an ISO standard method (ISO 16634). Samples are converted to gases by heating in a combustion tube which gasifies samples. Interfering components are removed from the resulting gas mixture. The nitrogen compounds in the gas mixture or a representative part of them are converted to molecular nitrogen, which is quantitatively determined by a thermal conductivity detector. The nitrogen content is calculated by a microprocessor. To estimate the protein content based on nitrogen the following factors where used: Wheat protein, 5.7; casein and soy 6.25; rice 5.95.

Average Molecular Weight

An average apparent MW value was measured by measuring OPA-N (Frister H. et al. 1988). OPA-N does not give a direct indication of MW but only the amount of end amine groups per sample. An apparent MW value can be gotten by dividing the total amount of nitrogen (total amount of Nitrogen is measured with the Dumas method described above) found with the OPA-N value using the following formula:

(Total N/OPA-N)*100=apparent MW

Mono- and Diglyceride

Method to quantify Mono- and diglyceride see Morrison et al. 1975.

Degree of conjugation is determined as follows First OPA-N value is divided by the total amount of nitrogen i.e. free amino roup divided by total amount of nitrogen from all amino acids. Then calculate the % reduction of this ratio after conjugation.

Degree of conjugation=[(OPA-Nₛₜₐᵣₜ/Nitrogenₛₜₐᵣₜ)−(OPA-N_{end}/Nitrogen_{end})]/(OPA-Nₛₜₐᵣₜ/Nitrogenₛₜₐᵣₜ)

OPA-Nₛₜₐᵣₜ is the OPA-N value of hydrolyzed protein without conjugation reaction and OPA-N end is the OPA-N value after conjugation reaction. Similarly, Nitrogenₛₜₐᵣₜ is the total nitrogen content of the hydrolyzed protein without conjugation reaction while Nitrogen_{end} is the total nitrogen content after conjugation reaction. The ratios are used to account for the dilution effect which occurs when sugar is added to the system therefore both total nitrogen and OPA-N is directly reduced by the dilution. However, by using the ratios only the absolute reduction in free amino groups are calculated.

Sensory Evaluation for Bitterness

Samples are tested as 1% peptide solution in water at room temperature using five trained sensory evaluators. To eliminate dilution effect, all samples are adjusted to contain only 1% peptide no matter how much sugar was added. Evaluators are given a standard (non-conjugated hydrolysate) to compare and set that standard to a bitterness of 3. If any change in bitterness can be detected, evaluators give a lower rating for less bitterness and higher rating for higher bitterness. Therefore, lower “bitterness number” means that the system has less bitter taste.

Materials

The following materials were used:

NaOH, HCl, Sulfuric acid, citric acid, lactic acid, Ca(OH)₂, Sigma-Aldrich (St. Luis Mo. USA) Pea protein (Pea protein 72%, Agrident, Amsterdam, Netherlands), soy protein (Unico 75 IP, Vitablend Nederland B.V. Wolvega, Netherlands), wheat protein (Gluvital 21000, Cargill Germany GmbH, Krefeld, Germany), rice protein (Remipro N80+, Beneo Remy N.V. Leuven-Wijgmaal, Belgium), casein (Acid Casein 741, Fonterra Ltd, Auckland, New Zeeland),

Alcalase 2.4 L FG, Novozymes (Novozymes NS, Gagsvaerd, Dennmark), Clarcel DIC-B (Ludwig Schulz GmbH, Langula, Germany) Spongolit 455, BASF SE (Ludwigshafen, Germany), Gluadin AGP, BASF SE (Ludwigshafen, Germany). Hyfoama 77, Kerry Group (Tralee, Republic of Ireland)

### EXAMPLES

Spongolit™, Hyfoama™ and several wheat protein hydrolysates Examples according to the invention (W1 to W7) and casein hydrolysates (C1 to C18) hydrolyzed according to above method were applied in the standard cake recipe with starch or flour/starch in varying amounts of emulsifier. Example W2, 3, 4 correspond to the commercial wheat hydrolysate Gluadin AGP, generally applied in cosmetics. C18 has higher concentration (w/w) as the hydrolysate includes 30% glucose and corresponds to 2.4% unconjugated hydrolsate.

TABLE 2
Results of the baking tests and structure analysis.

| | | | Apparant | | | | Batter | | Cake structure |
|---|---|---|---|---|---|---|---|---|---|
| | | | MW(Da) | Solubility | conc. | Recipe Type | Density | Volume | (rating 1 is best |
| Example | Protein type | Filtered | using OPA-N | (w/w%) | (w/w%) | (see Table 1) | (g/L) | (ml) | 5 is worst) |
| Spongolit | N/A | N/A | NIA | N/A | 3.2 | flour/starch | 320 | 3400 | 1 |
| | | | | | | recipe | | | |
| Hyfoama 77 | Wheat protein | Not | 3450 | 100 | 1.6 | starch recipe | 388 | 3720 | 2 |
| Kerry I | | known | | | | | | | |
| Hyfoarna 77 | Wheat protein | Not | 3450 | 100 | 2.4 | starch recipe | 268 | 4200 | 2 |
| Kerry II | | known | | | | | | | |
| Hyfoama | Wheat protein | Not | 3450 | 100 | 3.2 | starch recipe | 260 | 4680 | 2 |
| 77 Kerry III | | known | | | | | | | |
| W1 | Wheat protein | No | 1653 | 97 | 2.4 | starch recipe | 356 | 3700 | 1 |
| W2 | Wheat protein | Yes | 1675 | 97 | 2.4 | starch recipe | 412 | 3510 | 1 |
| W3 | Wheat protein | Yes | 1675 | 97 | 3.2 | starch recipe | 300 | 4000 | 1 |
| W4 | Wheat protein | Yes | 1675 | 97 | 4.8 | starch recipe | 240 | 4200 | 1 |
| W5 | Wheat protein | No | 1967 | 88 | 2.4 | starch recipe | 376 | 3700 | 1 |
| W6 | Wheat protein | No | 1967 | 88 | 3.2 | starch recipe | 320 | 3870 | 1 |
| W7 | Wheat protein | No | 1923 | 88 | 2.4 | starch recipe | 396 | 3570 | 1 |
| Cl | Casein | No | 800 | 100 | 1.6 | starch recipe | 308 | 4080 | 1 |
| C2 | Casein | No | 800 | 100 | 2.0 | starch recipe | 264 | 4180 | 1 |
| C3 | Casein | No | 694 | 100 | 1.6 | starch recipe | 312 | 4120 | 1 |
| C4 | Casein | No | 721 | 100 | 1,6 | starch recipe | 308 | 4060 | 1 |
| C5 | Casein | No | 755 | 100 | 1.6 | starch recipe | 296 | 4000 | 1 |
| C6 | Casein | No | 863 | 100 | 1,6 | starch recipe | 308 | 3930 | 1 |
| C7 | Casein | No | 863 | 100 | 3.2 | flour/starch | 384 | 4300 | 1 |
| | | | | | | recipe | | | |
| C8 | Casein | No | 832 | 100 | 1.2 | starch recipe | 372 | 3560 | 1 |
| C9 | Casein | No | 683 | 100 | 1.2 | starch recipe | 380 | 3640 | 1 |
| C11 | Casein | No | 683 | 100 | 2 | flour/starch | 384 | 3550 | 1 |
| | | | | | | recipe | | | |
| C12 | Casein | No | 683 | 100 | 2.4 | flour/starch | 316 | 4020 | 1 |
| | | | | | | recipe | | | |
| C13 | Casein | No | 832 | 100 | 2.4 | flour/starch | 360 | 3750 | 1 |
| | | | | | | recipe | | | |
| C17 (Neutralized | Casein | No | 683 | 100 | 1.6 | starch recipe | 304 | 3950 | 1 |
| with Phosphoric | | | | | | | | | |
| acid | | | | | | | | | |
| C18 (conjugated | Casein- | No | 683 | 100 | 3.4 | starch recipe | 300 | 3800 | 1 |
| with 30% | conjugate | | | | | | | | |
| Glucose) | | | | | | | | | |

TABLE 3
Conditions and results of conjugation reaction and bitter taste evaluation
of Example C9 hydrolysate of table 2

| | Casein | | | | | | Degree | Bit- |
|---|---|---|---|---|---|---|---|---|
| | hydroly- | Glu- | | | | | of conju- | ter |
| | sate (Dry | cose | Water | | Temp | Time | gation | taste |
| Trial Nr | matter) g | (g) | (g) | pH | (°C.) | (min) | (%) | (0-3) |
| standard | 100 | — | — | — | — | — | 0.0 | 3 |
| 1 | 70 | 30 | 86 | 8.5 | 65 | 60 | 27.8 | 1.4 |
| 2 | 80 | 20 | 98 | 8.5 | 65 | 60 | 20.2 | 1.5 |
| 3 | 90 | 10 | 110 | 8.5 | 65 | 60 | 11.3 | 1.9 |
| 4 | 80 | 20 | 98 | 8 | 65 | 60 | 20.0 | 1.5 |
| 5 | 80 | 20 | 98 | 8.5 | 85 | 30 | 29.8 | 1.4 |

### REFERENCES

Bennion E. B. and Bamford, G. S. T. (1997). The technology of cake making. Ed 6. London: Blackie Academic & Professional, pp. 275-289.
Eugénie, S. P. Fabrice, D. Gerard, C. Samir, M. (2014). Effect of bulk viscosity and surface tension kinetics on structure of foam generated at the pilot scale. Food Hydrocolloids, v. 34, pp. 104-111.
Richardson, G. Bergenståhl, B. Langton, M. Stading, M. Hermansson A. M. (2004) The function of alfa-crystalline emulsifiers on expanding foam surfaces. Food Hydrocolloids, v 18, pp 655-663
Tavano O. L. (2013) Protein Hydrolysis using proteases: An important tool for food biotechnology. Journal of Molecular Catalysis B: Enzymatic, v 90, pp 1-11.
Provansal, M. P. M. Cuq J. A. Cheftel J. C. (1975). Chemical and nutritional modifications of sunflower proteins due to alkaline processing. Formation of amino acid cross-links and isomerization of lysine residues. Journal of agriculture and food chemistry, v 23, pp 938-943.
Frister H. Meisel H. Schlimme E. (1988) OPA method modified by use of N,N-dimethyl-2-mercaptoethylammonium chloride as thiol component. Anal. Chem. V 330, pp 631-633.
Tamura M. Mori N. Miyoshi T. Koyama S. Kohri H. and Okai H. (1990). Practical debittering using model peptides and related compounds. Agricultural and biological chemistry, v 54 (1), pp 41-51
Bumberger E. Belitz H.-D. (1993). Bitter taste of enzymic hydrolysates of casein. Zeitschrift für Lebensmittel Untersuchung and Forschung, v 197 pp 14-19.
Lund M. N. and Ray C. A. (2017) Control of Maillard reactions in foods: Strategies and chemical mechanism. Agricultural and food chemistry, v 65, pp 4537-4552.
Morrison, W. R. Mann, D. L. Soon, W. Conventry A. M. (1975). Selective extraction and quantitative analysis of non-strarch and starch lipids from wheat flour. Journal of the science of food and agriculture, v. 26 (4), pp 507-521.

1.-21. (canceled)

22. Use of a protein hydrolysate for the preparation of baked goods, wherein the molecular weight of the protein hydrolysate is between 600 and 2400 Da and the solubility of the protein hydrolysate at least 90 and the standard batter density after whipping is below 450 g/l.

23. Use according to claim 22, wherein the protein is selected from plant or animal proteins, preferably at least one selected from the group consisting of wheat, soy, rice, potato, pea, sunflower, rape seed, lupin and milk protein.

24. Use according to claim 22, wherein the standard batter density after whipping is below 420 g/l.

25. Use according to claim 22, wherein the maximum molecular weight of the protein hydrolysate is 2300 Da.

26. Use according to claim 22, wherein the minimum molecular weight is 650 Da.

27. Use according to claim 22, wherein the molecular weight of a casein hydrolysate is between 650 and 1000 Da.

28. Use according to claim 22, wherein the molecular weight of a wheat protein hydrolysate is between 1300 and 2200 Da.

29. Use according to claim 22, wherein the amount of protein hydrolysate in a starch based batter is at least 0.8% (w/w).

30. Use according to claim 22, wherein the amount of protein hydrolysate, in a wheat flour based batter is at least 2.0% (w/w).

31. Use according to claim 22, wherein the protein hydrolysate is an enzymatically hydrolyzed protein hydrolysate.

32. Use according to claim 22, wherein the protein hydrolysate is unfiltered after hydrolysis and/or pH neutralized by acids selected from the group consisting of citric acid, lactic acid, phosphoric acid, hydrochloric acid and sulfuric acid.

33. Use according to claim 22, wherein the batter of the baked goods is free from isolated emulsifiers selected form the group consisting of Lecithin (E322); Polysorbates (E432-436); Ammonium phosphatides (E442); Sodium, potassium and calcium salts of fatty acids (E470); Mono- and diglycerides of fatty acids (E471); Acetic acid ester of mono and diglycerides (E472a); Lactic acid ester of mono and diglycerides (E472b); Citric acid ester of mono and diglycerides (E472c); Diacetyl tartaric acid esters of mono- and diglycerides (E472e); sucrose esters of fatty acids (E473); sucroglycerides (E474); Propylene Glycol Esters of Fatty Acids (E477); Polyglycerol ester of fatty acid (E475); polyglycerol ester of caster oil fatty acids (E476); thermally oxidized soya bean oil interacted with mono- and diglycerides of fatty acids (E479) and sodium and calcium stearyl lactylate (E481 and E482).

34. Use according to claim 22, wherein the batter of baked goods is comprising flour and/or starch and the amount of Mono- and Di-glycerides in the flour is below 1 g/kg.

35. Use according to claim 22, wherein the volume of a standard cake comprising the protein hydrolysate is at least 3500 ml.

36. Use according to claim 22, wherein the hydrolysate is used as a lyophilized powder.

37. Use according to claim 22, wherein the hydrolysate is conjugated with at least one reducing sugar.

38. Use according to claim 37, wherein the reducing sugar is selected from the group consisting of glucose, fructose, maltose, lactose, galactose, cellobiose, glyceraldehyde, ribose xylose and mannose.

39. Use according to claim 37, wherein the degree of conjugation is at least 10%.

40. Use according to claim 37, wherein the molar ratio of reducing sugar to peptide is from 0.5 to 2.0.

41. A conjugated protein hydrolysate, wherein the solubility of the protein hydrolysate at least 90%, the hydrolysate is conjugated with a reducing sugar selected from the group consisting of glucose, fructose, maltose, lactose, galactose, cellobiose, glyceraldehyde, ribose xylose and mannose, and the degree of conjugation is at least 10%, the protein is casein and the molecular weight of the protein hydrolysate is between 600 and 2400 Da.

42. The conjugated protein hydrolysate according to claim 41, wherein the molar ratio of reducing sugar to peptide is from 0.5 to 2.0.

43. A preparation of baked goods which comprises a protein hydrolysate, wherein the molecular weight of the protein hydrolysate is between 600 and 2400 Da and the solubility of the protein hydrolysate at least 90 and the standard batter density after whipping is below 450 g/l.
